(19) United States
(12) Patent Application Publication
(10) Pub. No.: US 2026/0357999 A1
(43) Pub. Date: Nov. 12, 2026

(54) ADJUSTABLE FAN FOR A COOKING APPLIANCE

(71) Applicant: Haier US Appliance Solutions, Inc., Wilmington, DE (US)

(72) Inventor: Bagawathkumar Chellappan, Prospect, KY (US)

(21) Appl. No.: 19/200,813

(22) Filed: May 7, 2025

(51) Int. Cl. F24C 15/20; F04D 25/02; F04D 29/26; F04D 29/40; H05B 6/64

(52) U.S. Cl. CPC F24C 15/2071; F04D 25/02; F04D 29/26; F04D 29/403; F24C 15/2035; H05B 6/64

(57) ABSTRACT

A cooking appliance includes a casing, a cooking chamber, a circulation conduit including, and a door mounted to the casing. Moreover, the appliance includes a fan assembly positioned within the conduit that includes a discharge housing including discharge ports. The assembly includes a fan housing mounted within the discharge housing and including an outlet. The fan housing is rotatable within the discharge housing to align the outlet with a selected discharge port. Furthermore, the assembly includes an impeller rotatably mounted within the fan housing for circulating air through the outlet of the fan housing and the selected discharge port. Moreover, the assembly includes a drive wheel including circumferentially arrayed teeth for engaging gear teeth. Movement of the gear rotates the wheel and fan housing. Moreover, the assembly includes a gear mounting structure positioned on the discharge housing that includes a support for supporting the gear permitting gear rotation.

### FIELD

The present subject matter relates generally to cooking appliances, and more particularly to fans in over-the-range cooking appliances.

### BACKGROUND

Over-the-range cooking appliances, such as over-the-range microwave appliances, are generally mounted above a cooktop of an oven range appliance. In addition to providing for heating of food and beverage items, certain over-the-range microwave appliances include a circulation system. When activated, the circulation system can draw fumes, smoke, grease, and/or steam away from the cooktop of the oven range appliance. Circulation systems generally include a fan for drawing a flow of air into the circulation system and a grease filter for trapping grease entering the circulation system.

Over-the-range microwave appliances generally have a radial blower fan that can be adjusted to recirculate or externally vent through an air vent. The installer of the microwave appliance can adjust the blower fan by removing certain parts to access and remove the radial blower fan, in order to reposition the fan. In other words, to switch venting directions after installation of the microwave appliance, the microwave appliance needs to be uninstalled and then reinstalled with the fan repositioned to change the venting direction. At times, installers may overlook ducting in the home and install the microwave appliance without properly orienting the blower fan to the functional position. This can lead to the failure of the magnetron and the cooking air not being vented in the desired direction for the consumer.

Accordingly, a cooking appliance with features for adjusting the circulation of the cooking appliance without uninstalling and reinstalling the fan would be useful.

### BRIEF DESCRIPTION

Aspects and advantages of the invention will be set forth in part in the following description, or may be apparent from the description, or may be learned through practice of the invention.

In one exemplary aspect of the present disclosure, a cooking appliance defining a vertical direction, a lateral direction, and a transverse direction is provided. The cooking appliance includes a casing. The casing defines a cooking chamber for receipt of food items for cooking. Additionally, the casing defines a circulation conduit. The circulation conduit includes an inlet and an outlet. Furthermore, the cooking appliance includes a door. The door is mounted to the casing to permit selective access to the cooking chamber. Moreover, the cooking appliance includes a fan assembly. The fan assembly is positioned within the circulation conduit. The fan assembly includes a discharge housing. The discharge housing includes a plurality of discharge ports. Furthermore, the fan assembly includes a fan housing. The fan housing includes an outlet. Moreover, the fan housing is mounted within the discharge housing. Additionally, the fan housing is selectively rotatable within the discharge housing to align the outlet with a selected one of the plurality of discharge ports. Furthermore, the fan assembly includes an impeller. The impeller is rotatably mounted within the fan housing. Rotation of the impeller circulates air through the outlet of the fan housing and the selected one of the plurality of discharge ports. Moreover, the fan assembly includes a drive wheel. The drive wheel includes a plurality of teeth circumferentially arrayed around the drive wheel and configured to engage teeth of a gear, whereby movement of the gear rotates the drive wheel and the fan housing. Moreover, the fan assembly includes a gear mounting structure. The gear mounting structure is positioned on the discharge housing. Furthermore, the gear mounting structure includes a support configured to support the gear therein and permit rotation of the gear.

In another exemplary aspect of the present disclosure, a cooking appliance defining a vertical direction, a lateral direction, and a transverse direction is provided. The cooking appliance includes a casing. The casing defines a cooking chamber for receipt of food items for cooking. Additionally, the casing defines a circulation conduit. The circulation conduit includes an inlet and an outlet. Furthermore, the cooking appliance includes a door. The door is mounted to the casing to permit selective access to the cooking chamber. Moreover, the cooking appliance includes a fan assembly. The fan assembly is positioned within the circulation conduit. The fan assembly includes a discharge housing. The discharge housing includes a plurality of discharge ports. Furthermore, the fan assembly includes a fan housing. The fan housing includes an outlet. Moreover, the fan housing is mounted within the discharge housing. Additionally, the fan housing is selectively rotatable within the discharge housing to align the outlet with a selected one of the plurality of discharge ports. Furthermore, the fan assembly includes an impeller. The impeller is rotatably mounted within the fan housing. Rotation of the impeller circulates air through the outlet of the fan housing and the selected one of the plurality of discharge ports. Moreover, the fan assembly includes a drive wheel. The drive wheel includes a plurality of teeth circumferentially arrayed around the drive wheel and configured to engage teeth of a gear, whereby movement of the gear rotates the drive wheel and the fan housing. Moreover, the fan assembly includes a gear mounting structure. The gear mounting structure includes a first flange and a second flange spaced apart from the first flange and is configured to support the gear therebetween.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example cooking appliance according to an example embodiment of the present subject matter mounted to a kitchen cabinet above an oven range appliance.

FIG. 2 provides a side, section view of the example cooking appliance and the oven range appliance of FIG. 1.

FIG. 3 provides a perspective view of a fan assembly of a cooking appliance, such as the example cooking appliance of FIG. 1.

FIG. 4 provides an exploded perspective view of the fan assembly of FIG. 3.

FIG. 5 provides a front view of the fan assembly of FIG. 3.

FIG. 6 provides a side view of the fan assembly of FIG. 3.

FIG. 7 provides a perspective view of an example embodiment of an example cooking appliance with the fan assembly of FIG. 3 in a first position.

FIG. 8 provides a perspective view of an example embodiment of an example cooking appliance with the fan assembly of FIG. 3 in a second position.

FIG. 9 provides a perspective view of an example embodiment of an example cooking appliance with the fan assembly of FIG. 3 in a third position.

FIG. 10 provides a perspective view of the fan assembly of FIG. 3 with an example motor drive assembly mounted to the fan assembly.

FIG. 11 provides a side partial cross-sectional view of the fan assembly of FIG. 3 with the motor drive assembly of FIG. 10 mounted to the fan assembly.

FIG. 12 provides a front partial cross-sectional view of the fan assembly FIG. 3 with a portion of the motor drive assembly of FIG. 10 mounted to the fan assembly.

FIG. 13 provides a perspective view of the fan assembly of FIG. 3 with a tension member connected to the drive wheel.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

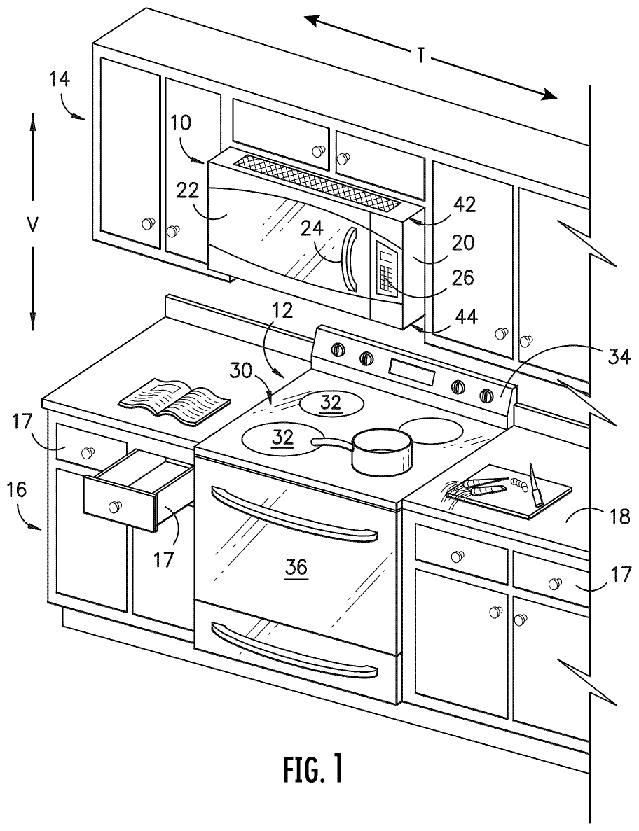

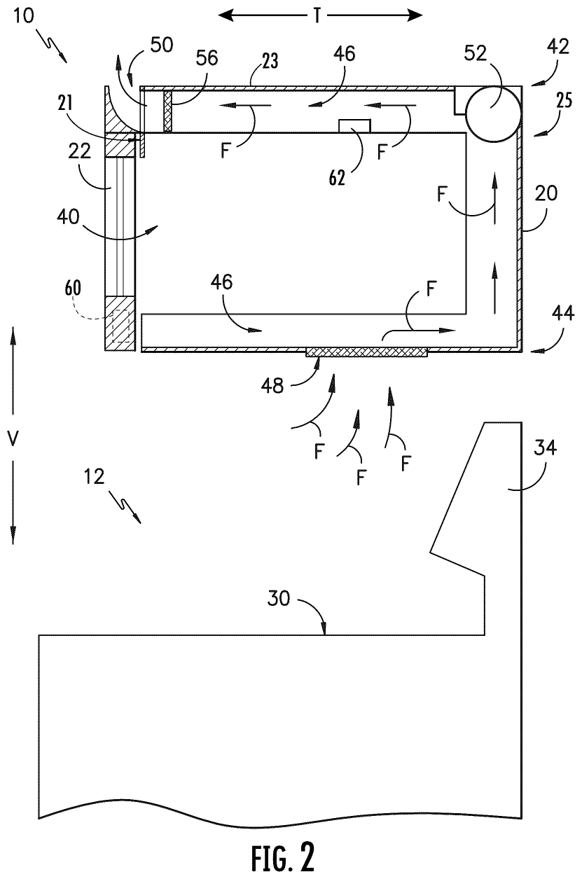

FIG. 1 provides a perspective view of a cooking appliance, described herein as a microwave appliance 10, according to an example embodiment of the present subject matter. Microwave appliance 10 generally defines a vertical direction V, a lateral direction L, and a transverse direction T (FIG. 2), each of which is mutually perpendicular, such that an orthogonal coordinate system is generally defined. Microwave appliance 10 is shown in FIG. 1 mounted to an upper set of kitchen cabinets 14 above an oven range appliance 12, e.g., along the vertical direction V. Microwave appliance 10 shown in FIG. 1 is commonly referred to as an over-the-range microwave. It should be understood that, in alternative example embodiments, the present subject matter may be used in any other suitable cooking appliance, such as an oven appliance or any other suitable microwave appliance.

As discussed above, microwave appliance 10 is mounted to upper set of kitchen cabinets 14. Upper set of kitchen cabinets 14 is positioned above a base set of kitchen cabinets 16, e.g., along the vertical direction V. Base set of kitchen cabinets 16 includes countertops 18 and drawers 17. Microwave appliance 10 is positioned above base set of kitchen cabinets 16, e.g., along the vertical direction V. Oven range appliance 12 is received within base set of kitchen cabinets 16 below microwave appliance 10. In particular, a cooking surface 30 of oven range appliance 12 is positioned, e.g., directly, below microwave appliance 10 along the vertical direction V. Microwave appliance 10 can include features such as an air handler or fan assembly 52 (FIG. 2) that can draw cooking vapors and/or smoke away from cooking surface 30 and out of the kitchen containing microwave and oven range appliances 10 and 12.

Microwave appliance 10 is configured for receipt of food items for cooking. In particular, microwave appliance 10 includes a cabinet or casing 20 and a door 22 that permits selective access to an interior of microwave appliance 10 and casing 20. Door 22 includes a handle 24 that a user can pull to open door in order to insert food items into microwave appliance 10. Microwave appliance 10 also includes controls 26 that permit a user to make selections for cooking of food items, e.g., a duration of a cooking cycle of microwave appliance 10 and/or a power setting for the cooking cycle of microwave appliance 10.

As discussed above, oven range appliance 12 includes cooking surface 30. Cooking surface 30 includes heated portions 32 that may be heated by heating elements (not shown), e.g., electrical resistive heating elements, gas burners, induction heating elements, and/or any other suitable heating element or combination of heating elements. Oven range appliance 12 also includes a door 36 that permits access to a heated compartment (not shown) of oven range appliance 12, e.g., for cooking or baking of food items therein. A control panel 34 of oven range appliance 12 can permit a user to make selections for cooking of food items, e.g., a duration of a cooking cycle of oven range appliance 12 and/or a power setting for the cooking cycle of oven range appliance 12.

FIG. 2 provides a side, section view of microwave appliance 10 and oven range appliance 12. As may be seen in FIG. 2, casing 20 extends between a top portion 42 and a bottom portion 44, e.g., along the vertical direction V. Thus, top and bottom portions 42 and 44 of casing 20 are spaced apart from each other, e.g., along the vertical direction V. In particular, casing 20 may include a front wall 21, a top wall 23, and a back wall 25 as will be described further hereinbelow. Casing 20 may generally define a cooking chamber 40 configured for receipt of food items for cooking. Door 22, which may be positioned adjacent to front wall 21 of casing 20 of microwave appliance 10, permits selective access to cooking chamber 40 of casing 20. In particular, door 22 of microwave appliance 10 is selectively adjustable between an open position (not shown) and a closed position (FIGS. 1 and 2). In the closed position, door 22 of microwave appliance 10 hinders access to cooking chamber 40 of casing 20. Conversely, door 22 of microwave appliance 10 permits access to cooking chamber 40 of casing 20 in the open position. A user can pull on handle 24 of door 22 of microwave appliance 10 in order to shift door 22 from the closed position shown in FIG. 2 to the open position.

Casing 20 also defines a circulation passage or conduit 46. Circulation conduit 46 has an inlet 48 and an outlet 50. Circulation conduit 46 extends between inlet 48 and outlet 50. Inlet 48 of circulation conduit 46 is positioned at or adjacent bottom portion 44 of casing 20, e.g., such that inlet 48 of circulation conduit 46 faces cooking surface 30 of oven range appliance 12. Conversely, outlet 50 of circulation conduit 46 is positioned at or adjacent top portion 42 of casing 20, e.g., such that outlet 50 of circulation conduit 46 faces away from cooking surface 30 of oven range appliance 12. Thus, inlet 48 and outlet 50 of circulation conduit 46 are spaced apart from each other, e.g., along the vertical direction V.

Microwave appliance 10 may include a fan assembly 52, such as an axial fan or a radial fan. Fan assembly 52 may be positioned within or adjacent circulation conduit 46. Fan assembly 52 may draw or urge a flow of air (shown with arrows F) through circulation conduit 46 when fan assembly 52 is in an activated state. Conversely, fan assembly 52 may not draw or urge flow of air F through circulation conduit 46 when fan assembly 52 is in a deactivated state. When fan assembly 52 is in the activated state, flow of air F enters circulation conduit 46 at, or through, inlet 48 of circulation conduit 46. In the present example embodiment, flow of air F is directed through circulation conduit 46 to outlet 50, and flow of air F can exit circulation conduit 46 at outlet 50 of circulation conduit 46. As described above, fan assembly 52 is described in a recirculation orientation where flow of air F is directed through circulation conduit 46 to outlet 50, however, fan assembly 52 may be configurable to direct flow of air F in other desired directions. Fan assembly 52, and other possible orientations of fan assembly 52 will be described in further detail hereinbelow.

Microwave appliance 10 may also include an air filter 56. Air filter 56 may be mounted to casing 20 such that flow of air F within circulation conduit 46 passes through air filter 56 when fan assembly 52 is in the activated state. In the example embodiment shown in FIG. 2, air filter 56 is positioned within circulation conduit 46 at outlet 50 of circulation conduit 46. It should be understood that in alternative example embodiments, air filter 56 may be positioned at any other suitable location on microwave appliance 10.

As may be seen in FIG. 2, microwave appliance 10 includes a controller 60. Operation of microwave appliance 10 is regulated by controller 60. Controller 60 is operatively coupled or in communication with various components of microwave appliance 10, including controls 26. In response to user manipulation of controls 26, controller 60 operates the various components of microwave appliance 10 to execute selected cycles and features.

Controller 60 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 60 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software. Controls 26 and other components of microwave appliance 10 may be in communication with controller 60 via one or more signal lines or shared communication busses.

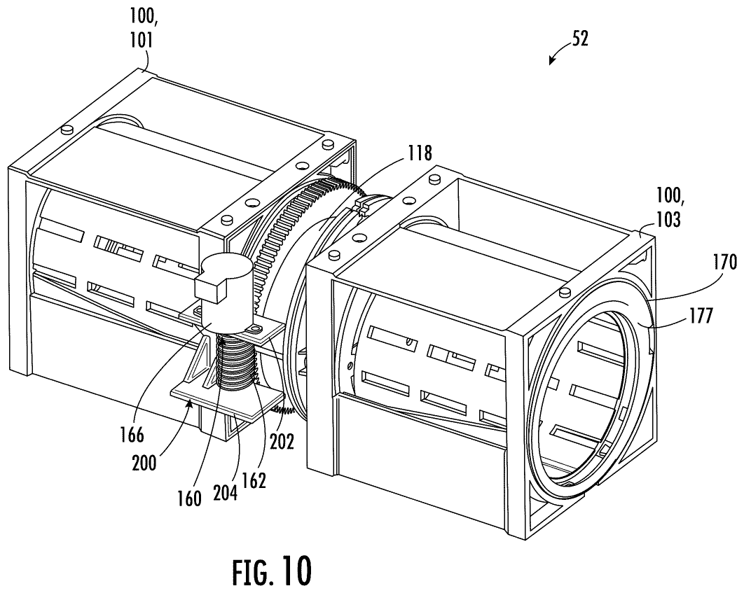

Microwave appliance 10 also includes a magnetron 62. Magnetron 62 is configured for generating microwaves and directing such microwaves towards or into cooking chamber 40 of casing 20. Magnetron 62 can be positioned at any suitable location within microwave appliance 10. For example, magnetron 62 may be mounted to casing 20, e.g., at or adjacent top portion 42 of casing 20, such that magnetron 62 is positioned at or adjacent cooking chamber 40 of casing 20. Controller 60 can selectively activate magnetron 62, e.g., in order to heat food or beverage items in cooking chamber 40, based at least in part on an activation signal received from controls 26. Further, controller 60 may also be in operative communication with fan assembly 52. For example, controller 60 may be in operative communication with a motor 166 of a motor drive assembly 160 (FIGS. 10-12) coupled to fan assembly 52. Thus, controller 60 may selectively adjust fan assembly 52, e.g., by motor 166, between the activated and deactivated states in order to regulate the flow of air F through circulation conduit 46.

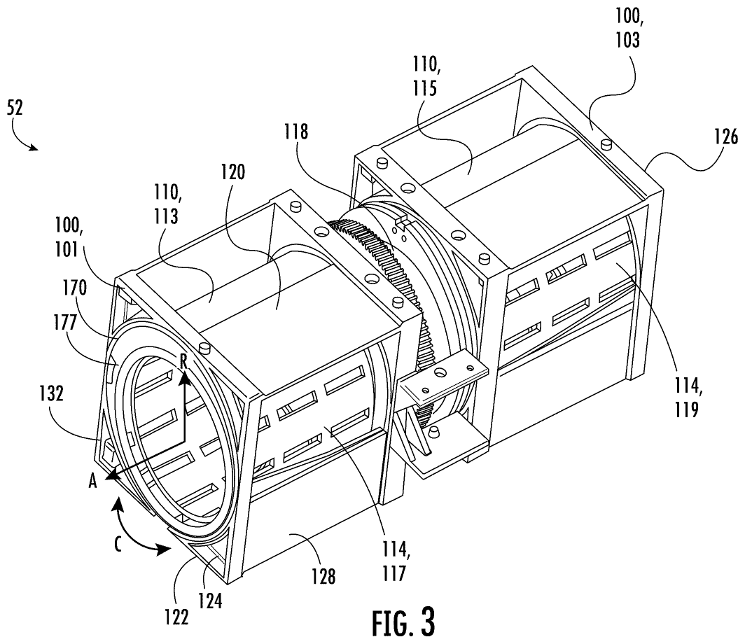

Illustrated in FIGS. 3 through 13 is an example embodiment of fan assembly 52 for use with a cooking appliance, such as microwave appliance 10. While described herein as used with microwave appliance 10, it should be appreciated that additionally, or alternatively, fan assembly 52 may be used in other cooking appliances such as oven appliances and/or other suitable appliances or structures such as heating, ventilation, and air conditioning systems (HVAC) or vent hood appliances.

As best illustrated in FIGS. 3 through 9, fan assembly 52 may include a discharge housing 100. In general, discharge housing 100 may extend between a top side 120, a bottom side 122, a first side wall 124, a second side wall 126, a front side 128, and a back side 132, e.g., discharge housing 100 may be generally rectangular in shape. Discharge housing 100 may be divided into two sections in the lateral direction L, e.g., discharge housing 100 may be two independent sections, a first discharge housing section 101 and a second discharge housing section 103, separated by a drive wheel 118 as described below. As such, drive wheel 118 may be positioned or sandwiched between first discharge housing section 101 and second discharge housing section 103 of discharge housing 100. In general, discharge housing 100 may be symmetrical across drive wheel 118 in order to provide modularity of fan assembly 52. However, while described herein as having two independent sections, it should be appreciated that, in some embodiments, discharge housing 100 may include a single section, e.g., first discharge housing section 101. In this respect, drive wheel 118 may be mounted to the single discharge housing section, e.g., to an outside portion thereof.

According to some example embodiments, discharge housing 100 may generally define a plurality of discharge ports, e.g., a first discharge port 102, a second discharge port 104, and a third discharge port 106. In example embodiments, the plurality of discharge ports 102, 104, and 106 includes three discharge ports, first discharge port 102, second discharge port 104, and third discharge port 106, facing in different directions. In general, the plurality of discharge ports 102, 104, and 106 may be oriented in any suitable direction. For example, first discharge port 102 may be defined in front side 128 of discharge housing 100 (e.g., the first discharge port 102 may generally face forward along the transverse direction T), second discharge port 104 may be defined in top side 120 of discharge housing 100 (e.g., the second discharge port 104 may generally face upward along the vertical direction V), and third discharge port 106 may be defined in back side 132 of discharge housing 100 (e.g., the third discharge port 106 may generally face backward along the transverse direction T). In some embodiments, the plurality of discharge ports 102, 104, and 106 may each be defined as pairs of discharge ports, such as one port on each section of discharge housing 100 forming pairs of discharge ports such that discharge housing 100 is symmetrical across drive wheel 118. However, in embodiments in which the discharge housing 100 includes a single section, the discharge housing 100 may define only one of each discharge port 102, 104, and 106.

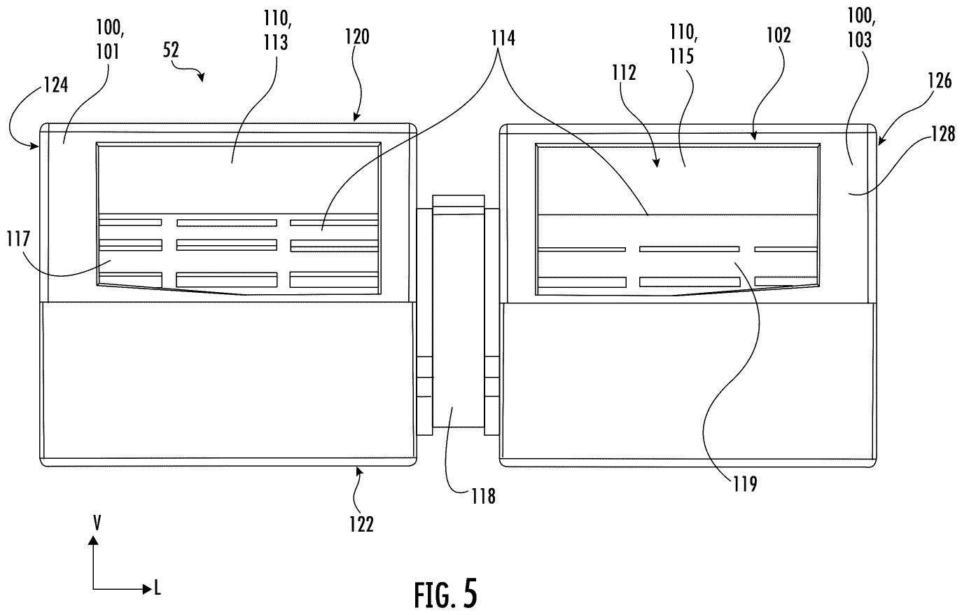

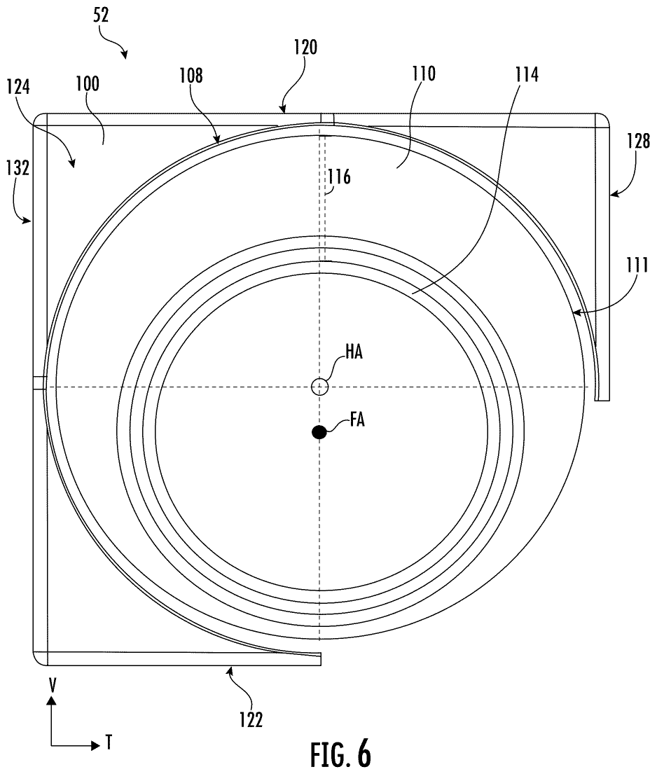

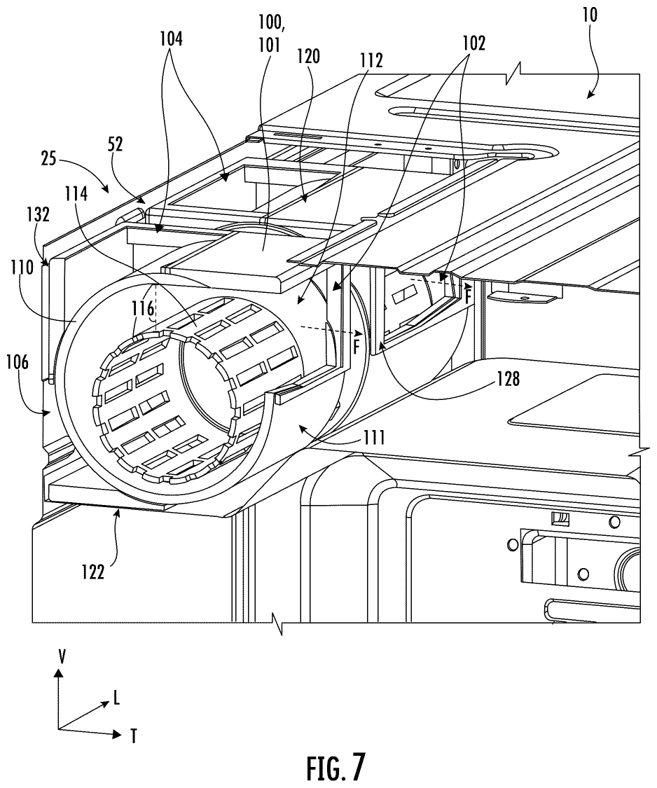

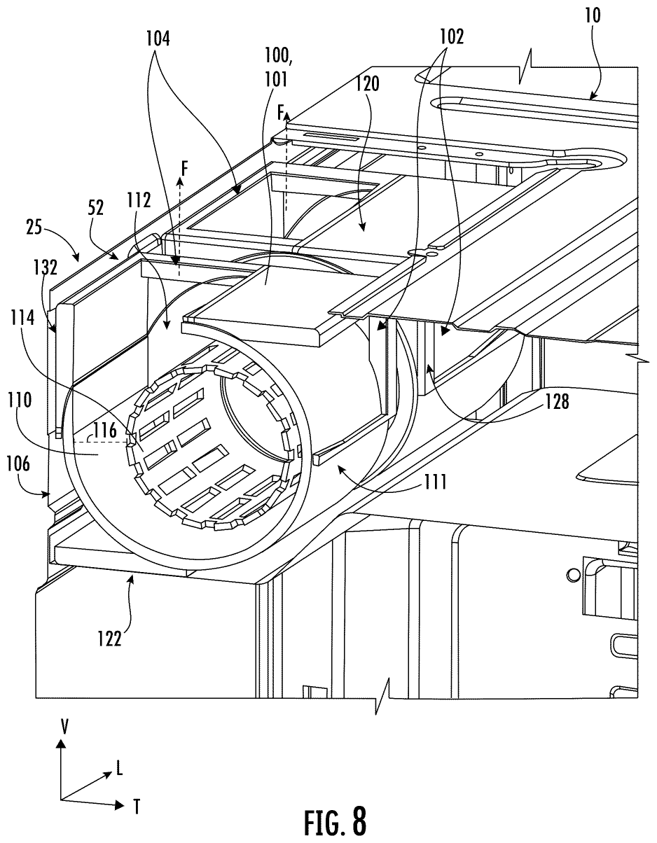

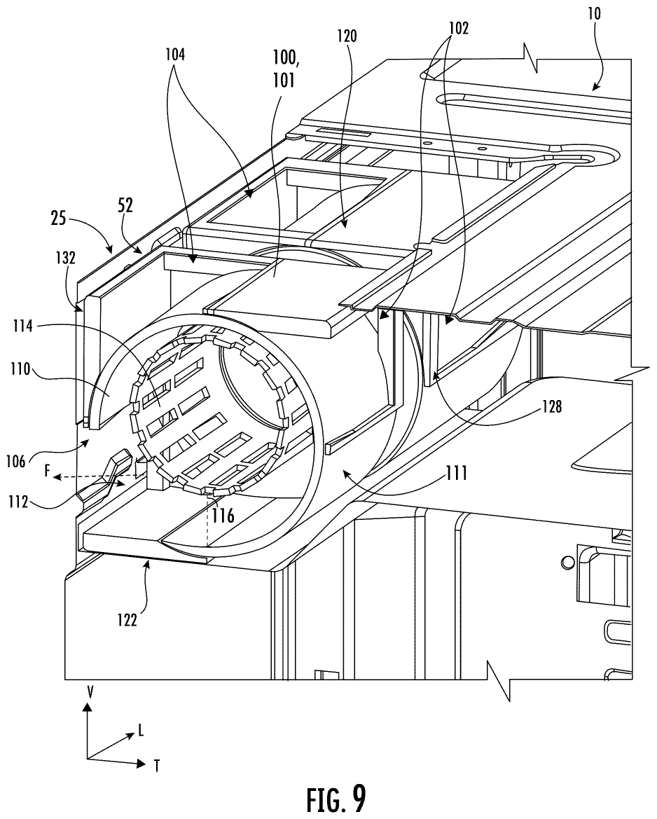

As best illustrated in FIGS. 3 and 5, a fan housing 110 may be mounted within discharge housing 100, e.g., fan housing 110 may include two sections, a first fan housing section 113 and a second fan housing section 115, one on each side of drive wheel 118, e.g., one in each section, first discharge housing section 101 and second discharge housing section 103 respectively, of discharge housing 100. In particular, as best illustrated in FIG. 6, discharge housing 100 may include an opening 108, e.g., a cylindrically shaped opening in each of first side wall 124 and second side wall 126 of discharge housing 100. Fan housing 110 may include an outer surface 111 and may be cylindrical, and concentric with opening 108 of discharge housing 100, such that fan housing 110 fits within opening 108 in both of the transverse direction T and vertical direction V. In other words, fan housing 110 may be laterally, in the lateral direction L, positioned within, and rotatable within, opening 108 of the discharge housing 100. For example, in the present example embodiment, fan housing 110 may be selectively rotatable within discharge housing 100. In particular, fan housing 110 may include an outlet 112, in each respective section within discharge housing 100, configured to align with a selected one of the plurality of discharge ports 102, 104, and 106. For example, fan housing 110 may be rotatable between a first position (as seen in FIG. 7), wherein outlet 112 is aligned with first discharge port 102 and flow of air F is directed through first discharge port 102, a second position (as seen in FIG. 8), wherein outlet 112 is aligned with second discharge port 104 and flow of air F is directed through second discharge port 104, and a third position (as seen in FIG. 9), wherein outlet 112 is aligned with third discharge port 106 and flow of air F is directed through third discharge port 106. Notably, fan housing 110 may be rotatable within discharge housing 100 while the discharge housing 100 and fan housing 110 are installed within microwave appliance 10. In example embodiments in which fan housing 110 is flexible, fan housing 110 may compress during rotation and spring back to its original position in order to align with the desired discharge port.

Furthermore, in some example embodiments, fan housing 110 may be any other suitable shape, such as a cube, cuboid, prism, etc. Furthermore, fan housing 110 may be made, at least partially, from any suitable rigid or flexible fire-retardant metal material, such as steel, nickel, titanium, iron, or some metal alloy combination thereof. Additionally, the fan housing 110 may be made, at least partially, using hot-rolled metal, cold-rolled metal, cast iron, and/or stainless steel.

Referring again to FIGS. 3 through 9, in general, fan housing 110 may include an impeller 114, e.g., in each section of fan housing 110. For example, a first impeller 117 may be positioned in first fan housing section 113 and a second impeller 119 may be positioned in second fan housing section 115. In particular, impeller 114 may be rotatably mounted within fan housing 110 such that impeller 114 may be configured to circulate air through outlet 112 of fan housing 110 and the selected one of the plurality of discharge ports 102, 104, and 106. For example, impeller 114 may be mechanically coupled to drive wheel 118 which, as will be described below, may be rotatable by a tension member or, alternatively, by a motor. The drive wheel 118 is generally configured to rotate impeller 114 within fan housing 110. As best illustrated in FIG. 6, impeller 114 may be mounted within fan housing 110 on a fan axis FA parallel to, and spaced apart from, a housing axis HA of the fan housing. As such, an inside gap 116 of fan housing 110 from impeller 114 may be non-uniform and progressively increasing towards outlet 112 of the fan housing 110. For example, as explained above, fan housing 110 may be selectively rotatable within discharge housing 100 between the plurality of discharge ports 102, 104, and 106, and offsetting fan axis FA from housing axis HA may thereby keep inside gap 116 of fan housing 110 from impeller 114 non-uniform and progressively increasing towards outlet 112 of fan housing 110 with respect to the selected one of the plurality of discharge ports 102, 104, and 106.

As described above, fan housing 110 may be rotatable between a first position in which outlet 112 is aligned with first discharge port 102, a second position in which outlet 112 is aligned with second discharge port 104, and a third position where outlet 112 is aligned with third discharge port 106. As illustrated in FIG. 7, fan housing 110 is shown in the first position, with outlet 112 aligned with first discharge port 102. When in the first position, flow of air F may flow out of first discharge port 102 of discharge housing 100 in the transverse direction T, such that air may be recirculated through circulation conduit 46 (e.g., as seen in FIG. 2). As illustrated in FIG. 8, fan housing 110 is shown in the second position, with outlet 112 aligned with second discharge port 104. When in the second position, flow of air F may flow out of second discharge port 104 of discharge housing 100 in the vertical direction V, such that flow of air F may flow out an external duct (not shown) extending in the vertical direction V. Further, as illustrated in FIG. 9, fan housing 110 is shown in the third position, with outlet 112 aligned with third discharge port 106. When in the third position, flow of air F may flow out of third discharge port 106 of discharge housing 100 in the transverse direction T, opposite the direction of the first position, such that flow of air F may flow out back side 132 of discharge housing 100 and out an external duct (not shown) in the transverse direction T.

According to some example embodiments, fan assembly 52 includes drive wheel 118. The drive wheel 118 generally defines a radial direction R (FIG. 3), an axial direction A (FIG. 3), and a circumferential direction C (FIG. 3) such that a cylindrical coordinate system is generally defined. The term “radial” refers to the relative direction that is substantially perpendicular to an axial centerline of drive wheel 118. The term “axially” refers to the relative direction that is substantially parallel and/or coaxially aligned to an axial centerline of drive wheel 118. The term “circumferentially” refers to the relative direction that extends around the axial centerline of drive wheel 118.

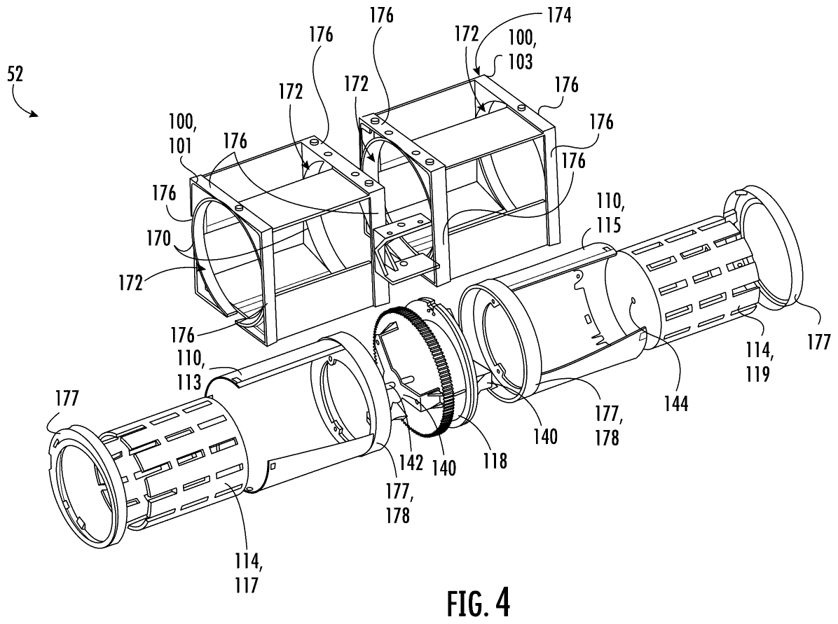

In general, fan housing 110 may be selectively rotatable within discharge housing 100 while installed within microwave appliance 10 by rotating drive wheel 118. For example, drive wheel 118 may include a mounting structure 140 (FIG. 4) protruding from a side of the drive wheel 118. The fan housing 110 may be coupled to or mounted on the mounting structure 140 such as by receiving fasteners, e.g., bolts, through aligned pairs of holes of an inner fan housing ring 178 coupled to the fan housing 110 and the mounting structure 140. As illustrated, in some embodiments, drive wheel 118 may be positioned or sandwiched between first discharge housing section 101 and second discharge housing section 103. As such, drive wheel 118 may include two mounting structures 140, one protruding from opposite lateral sides of drive wheel 118, such that first fan housing section 113 and second fan housing section 115 may be coupled to the drive wheel 118. Additionally, a shaft 142 may protrude from the side of the drive wheel 118, such as from the lateral side as shown in FIG. 4. The shaft 142 may be received through the impeller 114, e.g., a shaft hole 144 thereof, and fixed to the impeller 114. In this respect, rotation of the drive wheel 118 also rotates the impeller 114. As illustrated, drive wheel 118 may include two shafts 142, one protruding from the opposite lateral sides of drive wheel 118 that the mounting structures 140 protrude from, such that first impeller 117 and second impeller 119 may be coupled to the drive wheel 118. While described herein as positioned/sandwiched between first discharge housing section 101 and second discharge housing section 103, it should be appreciated that, in some other embodiments, drive wheel 118 may be positioned at any other suitable location, such as at first side wall 124 or second side wall 126.

According to some example embodiments, each discharge housing section 101, 103 may include two aperture collars 170 that define circumferential apertures 172 (FIG. 4). An exterior surface 174 may surround each of the aperture collars 170. For example, each aperture collar 170 may include groups of walls 176, such as two groups of four walls 176, each group of which forms an orthogonal enclosed shape, e.g., a square. Each group of four walls 176 may collectively include an exterior surface 174 that surrounds one of the aperture collars 170.

Additionally, the aperture collars 170 may be aligned with or approximately parallel to the housing axis HA. The aperture collars 170 may extend circumferentially around fan housing rings 177 (FIGS. 3, 4, 10), which are fixedly coupled to the first fan housing section 113 and the second fan housing section 115 and rotatable with the fan housing sections 113, 115. For example, one aperture collar 170 of the first discharge housing section 101 and one aperture collar 170 of the second discharge housing section 103 may each extend circumferentially around different inner fan housing rings 178 (FIG. 4) one of which is coupled to the first fan housing section 113 and the other of which is coupled to the second fan housing section 115. The inner fan housing rings 178 may also be directly coupled/attached to drive wheel 118 and may be rotatable within the aperture collars 170 by drive wheel 118, thereby rotating fan housing sections 113, 115.

Referring to FIGS. 10 through 12, notably, in some example embodiments, drive wheel 118 may be rotatable, such as electromechanically rotatable. In some embodiments, for example, drive wheel 118 may be coupled to a motor drive assembly 160, such as to a gear thereof. In this respect, drive wheel 118 may include a plurality of drive wheel teeth 121, which may be circumferentially arranged or arrayed around drive wheel 118. The plurality of drive wheel teeth 121 may engage a plurality of gear teeth or threading 163 of a gear 162 of motor drive assembly 160, such as threading 164 of a worm gear 162 shown in FIGS. 10 through 12. However, while described herein as engaged with or coupled to a worm gear, it should be appreciated that drive wheel 118 may be engaged with or coupled to any suitable gear, such as a helical gear, bevel gear, spur gear, or the like.

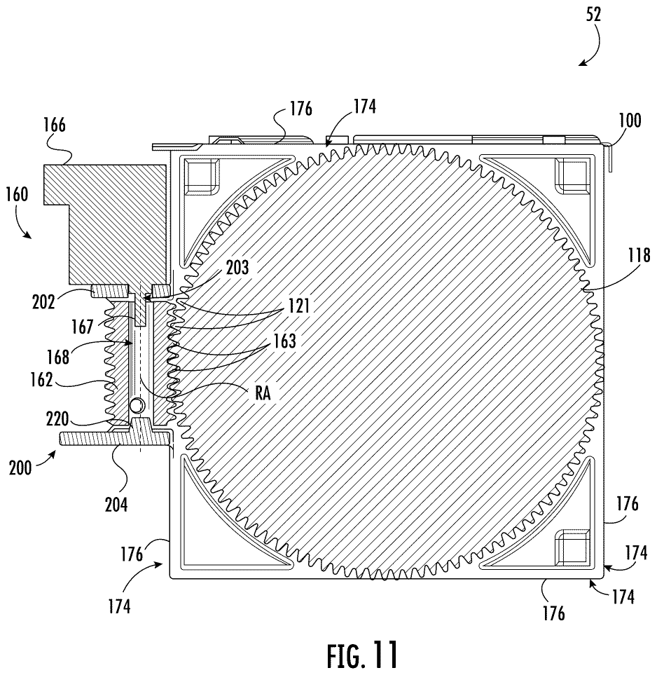

Additionally, the motor drive assembly 160 includes a motor 166, such as a stepper motor. The gear 162 may be coupled to motor 166. For example, as best illustrated in FIG. 11, an axial passage 168 may be defined partially or entirely through gear 162. The axial passage 168 may be aligned with a rotational axis RA of gear 162. A drive shaft 167 may extend from motor 166 that is rotatable by motor 166. When gear 162 is coupled to motor 166, drive shaft 167 may be aligned with and extend into/be received within axial passage 168 of gear 162 and fixed to gear 162. In this respect, gear 162 may be moved/rotated by motor 166. Movement/rotation of the gear 162, e.g., by motor 166, rotates drive wheel 118 and, thus, fan housing 110. As described above, motor 166 may be in operative communication with controller 60. As such, a user may activate motor 166 from controls 26 of microwave appliance 10 and/or from a dedicated fan user interface (not shown) of microwave appliance 10 and/or from a remote user interface device, e.g., tablet, smartphone, wirelessly connected to controller 60.

According to some example embodiments, fan assembly 52 includes a gear mounting structure 200 for supporting the gear 162 thereon while permitting rotation of the gear 162. The gear mounting structure 200 may be positioned on and attached to discharge housing 100. For example, as shown in FIGS. 10 through 12, gear mounting structure 200 may be attached to the exterior surface 174 described above, such as the exterior surface 174 surrounding one of the aperture collars 170 extending circumferentially around one of the inner fan housing rings 178 described above. Specifically, the gear mounting structure 200 may be positioned on and attached to such exterior surface 174 on the front side 128 of discharge housing 100. However, it should be appreciated that gear mounting structure 200 may be positioned on and attached to discharge housing 100 on any suitable side of discharge housing 100. As such, gear mounting structure 200 and, thus, the gear 162, may be positioned for desired engagement/contact between the gear 162 and drive wheel 118. In some embodiments, gear mounting structure 200 may be integrally coupled or formed with discharge housing 100 as a continuous piece, e.g., as a single continuous and monolithic piece forming a unitary body whereby the gear mounting structure 200 and the discharge housing 100 are integrally joined together without fasteners.

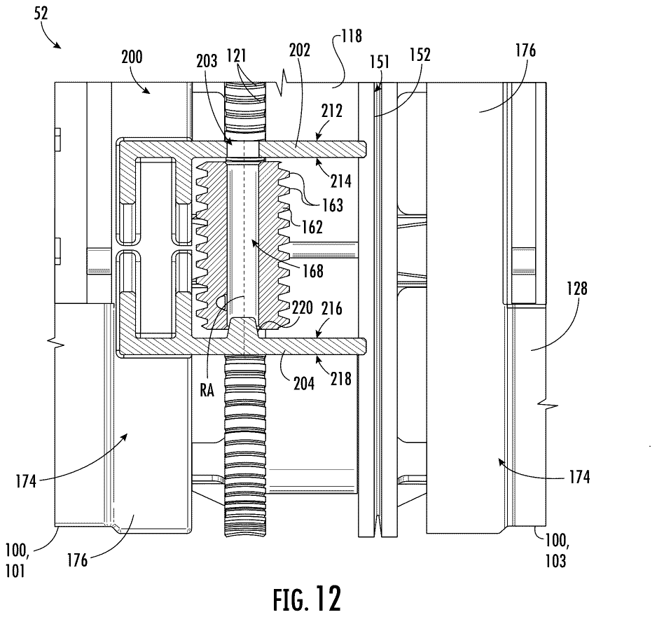

According to some example embodiments, gear mounting structure 200 may include a first flange, described herein as an upper flange 202, and a second flange, described herein as a lower flange 204 spaced apart from the upper flange 202, e.g., in the vertical direction V. While described herein as upper and lower flanges, it should be appreciated that the first flange and the second flange may be oriented in any suitable direction. For example, in some embodiments, the first flange and the second flange may be positioned on the top side 120 of discharge housing 100 and, thus, spaced apart from each other in a non-vertical direction, e.g., the transverse direction T. As best illustrated in FIG. 12, upper flange 202 may include a first or upper surface 212 and a second or lower surface 214 spaced apart from each other, e.g., in the vertical direction V. Likewise, lower flange 204 may include a first or upper surface 216 and a second or lower surface 218 spaced apart from each other, e.g., in the vertical direction V. As illustrated, the lower surface 214 of the upper flange 202 faces or opposes the upper surface 216 of the lower flange 204. Furthermore, as illustrated in FIGS. 10 through 12, the gear 162 may be positioned or sandwiched between the upper surface 216 of the lower flange 204 and the lower surface 214 of the upper flange 202. The rotational axis RA of the gear 162, which is described herein as a worm gear 162, may be approximately perpendicular to the upper flange 202 and the lower flange 204. Furthermore, threads 163 of worm gear 162 may protrude from underneath the flanges 202, 204 to engage the plurality of drive wheel teeth 121 of drive wheel 118 without interference of the plurality of drive wheel teeth 121 with the flanges 202, 204.

Additionally, in some embodiments, the motor 166 may be mounted to either the upper flange 202 or the lower flange 204, such as to the upper surface 212 of the upper flange 202. As best illustrated in FIG. 11, a shaft aperture 203 may be defined through the upper flange 202 through which the drive shaft 167 is received. Furthermore, drive shaft 167, shaft aperture 203, and axial passage 168 of gear 162 may all be aligned. In this respect, drive shaft 167 may be simultaneously received through shaft aperture 203 of upper flange 202 and axial passage 168 of gear 162.

According to some example embodiments, gear mounting structure 200 also includes a support 220 for supporting gear 162 thereon and for permitting rotation of gear 162 about rotational axis RA. Support 220 may protrude from either the upper flange 202, e.g., the lower surface 214 thereof, or the lower flange 204, e.g., the upper surface 216 thereof. For example, as shown in FIGS. 11 and 12, the support protrudes from the upper surface 216 of the lower flange 204. As illustrated, the support 220 may be received within the axial passage 168 of gear 162 and, thus, support gear 162 thereon. Additionally, support 220 may be axially aligned with, e.g., in the vertical direction, rotational axis RA of gear 162. Furthermore, support 220 may include a rounded outer surface, such as a circular or cylindrical outer surface to permit and facilitate rotation of gear 162 about support 220 and, thus, rotational axis RA. Moreover, in some embodiments, the support 220 and the drive shaft 167 are simultaneously received within axial passage 168 of gear 162 at different ends of gear 162 to provide support for gear 162. For example, drive shaft 167 may be received through axial passage 168 of gear 162 at a top end of gear 162 while support 220 is received through axial passage 168 of gear 162 at a bottom end of gear 162, which is spaced apart from top end of gear 162, e.g., in the vertical direction V.

While described here as moving/rotating due to movement of a motor drive assembly, e.g., motor drive assembly 160, it should be appreciated that gear 162 and, thus, drive wheel 118, may be manually rotated, such as by a fan control dial mechanically coupled to gear 162, whereby turning the fan control knob, e.g., by a user, directly rotates the gear 162 and, thus, drive wheel 118.

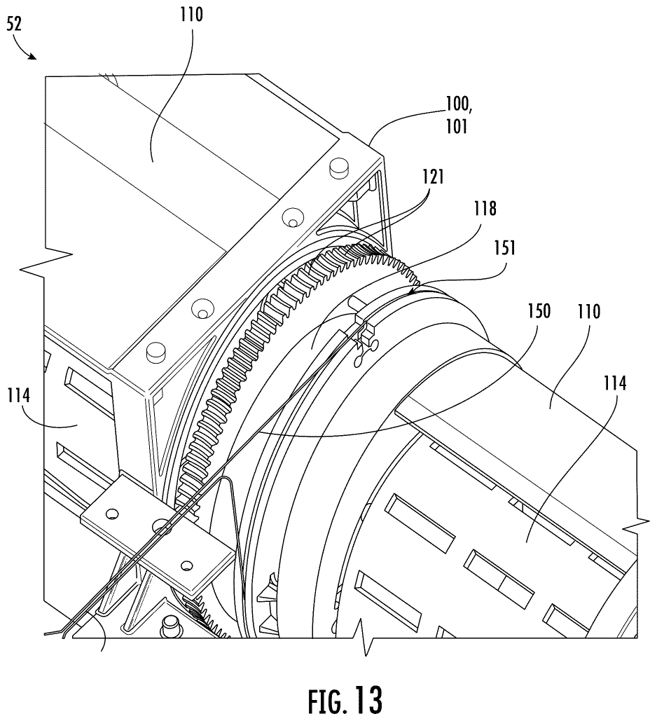

Additionally, while described herein as moving/rotating due to movement of a motor drive assembly, e.g., motor drive assembly 160, it should be appreciated that, in some embodiments, drive wheel 118 may alternatively be rotated in any other suitable manner, such as by a tension member 150. For example, as shown in FIG. 13, in some embodiments, drive wheel 118 may additionally include a groove 151, which may be defined circumferentially around drive wheel 118. Drive wheel 118 may include a contact surface 152 (FIG. 12) that is positioned within groove 151. The contact surface 152 may extend circumferentially around the drive wheel 118. Tension member 150 may engage at least a portion of the contact surface 152 of drive wheel 118. For example, tension member 150 may be looped around a portion of drive wheel 118 and, as such, may contact a portion of the contact surface 152. The tension member 150 may be utilized to provide tension/tensile force to rotate drive wheel 118 and, thus, fan housing 110 and impeller 114. As such, movement of tension member 150 rotates drive wheel 118 and, thus, fan housing 110 and impeller 114. The tension member 150 may be any suitable tension member such as a rope, cable, chain, belt, and/or the like. In this respect, the user may select/choose between rotating the drive wheel 118 and, thus, the fan housing 110 by moving the tension member 150 or by activating the motor 166 as described above.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance, the cooking appliance defining a vertical direction, a lateral direction, and a transverse direction, the cooking appliance comprising:
a casing defining a cooking chamber for receipt of food items for cooking and a circulation conduit, the circulation conduit including an inlet and an outlet;
a door mounted to the casing to permit selective access to the cooking chamber; and
a fan assembly positioned within the circulation conduit, the fan assembly comprising:
a discharge housing comprising a plurality of discharge ports;
a fan housing comprising an outlet, the fan housing mounted within the discharge housing, the fan housing selectively rotatable within the discharge housing to align the outlet with a selected one of the plurality of discharge ports;
an impeller rotatably mounted within the fan housing, whereby rotation of the impeller circulates air through the outlet of the fan housing and the selected one of the plurality of discharge ports;
a drive wheel coupled to the fan housing, the drive wheel comprising a plurality of teeth circumferentially arrayed around the drive wheel and configured to engage teeth of a gear, whereby movement of the gear rotates the drive wheel and the fan housing; and
a gear mounting structure positioned on the discharge housing, the gear mounting structure comprising a support configured to support the gear thereon and permit rotation of the gear.

2. The cooking appliance of claim 1, the discharge housing further comprising:
an aperture collar defining a circumferential aperture, the aperture collar extending circumferentially around a fan housing ring attached to the drive wheel, the fan housing ring rotatable within the aperture collar by the drive wheel; and
an exterior surface surrounding the aperture collar,
wherein, the gear mounting structure is positioned on the exterior surface.

3. The cooking appliance of claim 1, the cooking appliance further comprising:
the gear, an axial passage defined through the gear,
wherein, the support is axially aligned with a rotational axis of the gear and received within the axial passage.

4. The cooking appliance of claim 1, the gear mounting structure further comprising:
a first flange comprising a first surface and a second surface spaced apart from the first surface; and
a second flange comprising a first surface and a second surface spaced apart from the first surface, the second flange spaced apart from the first flange, the first surface of the second flange facing the second surface of the first flange,
wherein, the support of the gear mounting structure protrudes from one of the second surface of the first flange or the first surface of the second flange.

5. The cooking appliance of claim 4, the cooking appliance further comprising:
the gear, an axial passage defined through the gear,
wherein:
the gear is sandwiched between the second surface of the first flange and the first surface of the second flange; and
the support is axially aligned with a rotational axis of the gear and received within the axial passage.

6. The cooking appliance of claim 4, the cooking appliance further comprising:
the gear, an axial passage defined through the gear; and
a motor comprising a shaft coupled to the gear, the motor configured to rotate the gear,
wherein:
the shaft of the motor is aligned with the axial passage of the gear and is simultaneously received through the axial passage and one of the first flange or the second flange;
the support is axially aligned with a rotational axis of the gear and received within the axial passage; and
the shaft of the motor and the support are simultaneously received within the axial passage of the gear at different ends of the gear.

7. The cooking appliance of claim 1, wherein the plurality of discharge ports comprises three discharge ports facing in three different directions.

8. The cooking appliance of claim 7, wherein the discharge housing is defined between a top side, a bottom side, a first side wall, a second side wall, a front side, and a back side.

9. The cooking appliance of claim 8, wherein one of the three discharge ports is positioned on the top side, one of the three discharge ports is positioned on the front side, and one of the three discharge ports is positioned on the back side.

10. The cooking appliance of claim 1, wherein:
the fan housing comprises:
a first fan housing section; and
a second fan housing section;
the impeller is a first impeller;
the fan assembly further comprises a second impeller;
the discharge housing further comprises:
a first discharge housing section, the first fan housing section and the first impeller mounted within the first discharge housing section; and
a second discharge housing section spaced apart from the first discharge housing section, the second fan housing section and the second impeller mounted within the second discharge housing section; and
the drive wheel is positioned between the first discharge housing section and the second discharge housing section.

11. A cooking appliance, the cooking appliance defining a vertical direction, a lateral direction, and a transverse direction, the cooking appliance comprising:
a casing defining a cooking chamber for receipt of food items for cooking and a circulation conduit, the circulation conduit including an inlet and an outlet;
a door mounted to the casing to permit selective access to the cooking chamber; and
a fan assembly positioned within the circulation conduit, the fan assembly comprising:
a discharge housing comprising a plurality of discharge ports;
a fan housing comprising an outlet, the fan housing mounted within the discharge housing, the fan housing selectively rotatable within the discharge housing to align the outlet with a selected one of the plurality of discharge ports;
an impeller rotatably mounted within the fan housing, whereby rotation of the impeller circulates air through the outlet of the fan housing and the selected one of the plurality of discharge ports;
a drive wheel coupled to the fan housing, the drive wheel comprising a plurality of teeth circumferentially arrayed around the drive wheel and configured to engage teeth of a gear, whereby movement of the gear rotates the drive wheel and the fan housing; and
a gear mounting structure comprising a first flange and a second flange spaced apart from the first flange and configured to support the gear therebetween.

12. The cooking appliance of claim 11, the discharge housing further comprising:
an aperture collar defining a circumferential aperture, the aperture collar extending circumferentially around a fan housing ring attached to the drive wheel, the fan housing ring rotatable within the aperture collar by the drive wheel; and
an exterior surface surrounding the aperture collar,
wherein, the gear mounting structure is positioned on the exterior surface.

13. The cooking appliance of claim 11, wherein:
the first flange comprises a first surface and a second surface spaced apart from the first surface;
the second flange comprises a first surface and a second surface spaced apart from the first surface, the second flange spaced apart from the first flange, the first surface of the second flange facing the second surface of the first flange; and
the gear mounting structure further comprises a support protruding from one of the second surface of the first flange or the first surface of the second flange.

14. The cooking appliance of claim 13, the cooking appliance further comprising:
the gear, an axial passage defined through the gear,
wherein:
the gear is sandwiched between the second surface of the first flange and the first surface of the second flange; and
the support is axially aligned with a rotational axis of the gear and received within the axial passage.

15. The cooking appliance of claim 13, the cooking appliance further comprising:
the gear, an axial passage defined through the gear; and
a motor comprising a shaft coupled to the gear, the motor configured to rotate the gear,
wherein:
the shaft of the motor is aligned with the axial passage of the gear and is simultaneously received the axial passage and through one of the first flange or the second flange;
the support is axially aligned with a rotational axis of the gear and received within the axial passage; and
the shaft of the motor and the support are simultaneously received within the axial passage of the gear at different ends of the gear.

16. The cooking appliance of claim 11, wherein the plurality of discharge ports comprises three discharge ports facing in three different directions.

17. The cooking appliance of claim 16, wherein the discharge housing is defined between a top side, a bottom side, a first side wall, a second side wall, a front side, and a back side.

18. The cooking appliance of claim 17, wherein one of the three discharge ports is positioned on the top side, one of the three discharge ports is positioned on the front side, and one of the three discharge ports is positioned on the back side.

19. The cooking appliance of claim 11, wherein:
the fan housing comprises:
a first fan housing section; and
a second fan housing section;
the impeller is a first impeller;
the fan assembly further comprises a second impeller;
the discharge housing further comprises:
a first discharge housing section, the first fan housing section and the first impeller mounted within the first discharge housing section; and
a second discharge housing section spaced apart from the first discharge housing section, the second fan housing section and the second impeller mounted within the second discharge housing section; and
the drive wheel is positioned between the first discharge housing section and the second discharge housing section.
